(19) United States
(12) Patent Application Publication
(10) Pub. No.: US 2008/0094736 A1
(43) Pub. Date: Apr. 24, 2008

(54) METHOD OF MOUNTING OPTICAL COMPONENT AND OPTICAL PICKUP

(75) Inventors: Sho NAKAGOMI, Tokyo (JP); Teiichiro OKA, Tokyo (JP)

Correspondence Address: YOUNG LAW FIRM, P.C.;ALAN W. YOUNG, 4370 ALPINE ROAD, SUITE 106, PORTOLA VALLEY, CA, 94028, US

(73) Assignee: TDK CORPORATION, Tokyo (JP)

(21) Appl. No.: 11/870,410

(22) Filed: Oct. 10, 2007

(30) Foreign Application Priority Data
Oct. 18, 2006 (JP) 2006284381

(51) Int. Cl. G02B 7/02; H01S 4/00

(52) U.S. Cl. 359/811; 29/592.1

(57) ABSTRACT

A method of mounting an optical component is provided with the steps of pressing an optical component to a mounting surface of a housing, separating the optical component from the mounting surface within a prescribed distance while remaining parallel with the mounting surface, adjusting the position and angle of the optical component, and fixing the optical component to the mounting surface. The prescribed distance is preferably 1 μm or more and 300 μm or less. The step of fixing the optical component includes the steps of applying a UV-curable adhesive so that the optical component is affixed to the mounting surface, and fixing the optical component by irradiating UV light to cure the UV-curable resin.

### CROSS-REFERENCE TO RELATED APPLICATIONS

This application was first filed on Oct. 18, 2006, as Japanese Patent Application No. 2006-284381, which application is hereby incorporated herein by reference in its entirety and from which application foreign priority is hereby claimed under 35 U.S.C. §119(a)-(d).

### TECHNICAL FIELD

The present invention relates to a method of mounting an optical component when a photoelement or another optical component is fixed in a housing. The present invention also relates to an optical pickup manufactured using the method of mounting an optical component.

### BACKGROUND OF THE INVENTION

An optical recording and reproducing apparatus that records and reproduces optical discs and optical magnetic discs is provided with an optical pickup for recording information in prescribed areas on a track formed along the circumferential direction of the disc, or reproducing the information recorded in the prescribed areas on a track. The optical pickup is provided with two light sources having different wavelengths that correspond to two types of optical recording media such as CD and DVD, for example, and optical pickups provided with a plurality of photoelements to accommodate the optical recording mediums are in widespread use. Currently there are also optical pickups having a light source with three wavelengths, including Blu-ray Disc (BD), HD-DVD, and other formats.

FIG. 5 is a schematic diagram showing the general configuration of an optical pickup.

As shown in FIG. 5, an optical pickup 30 is provided with a laser diode 31, a diffraction grating 32 that divides laser light from the laser diode 31 into a plurality of beams, a collimator lens 33 that converts laser light emitted from the diffraction grating 32 into parallel light, a mirror 34 that guides the laser light converted into parallel light toward the optical disc, an object lens 35 that focuses the laser light on the disc surface, a beam splitter 36 that guides the light reflected from an optical disc 40 toward a photoelement 38, a sensor lens 37 for focusing light reflected from the beam splitter 36, a photoelement 38 that receives reflected light that has been focused by the sensor lens 37, and an object lens actuator 39 that controls with high precision the position of the object lens 35 in relation to the optical disc 40.

In the optical pickup 30 described above, the photoelement 38 must be positioned with high precision on the optical axis in order to achieve high quality recording and reproduction. For this reason, mounting a photoelement in a housing as described in Japanese Patent Application Laid-open No. 2005-3775, for example, entails preparing a substrate on which a photoelement is mounted, positioning the surface of the substrate and the mounting surface of the housing so that these surfaces face each other via a gap that is set within a range of 0.1 to 0.5 mm, applying a UV-curable adhesive so as to make contact with the side end surface of the substrate and the periphery of the mounting surface of the housing, and curing the UV-curable adhesive to fix the substrate in the housing.

FIG. 6 is a schematic plan view showing the configuration of a photoelement 38.

As shown in FIG. 6, the photoelement 38 is provided with a main beam photodetector that receives a main beam MB reflected by the optical disc 40, and two sub-beam photodetectors 42 and 43 that receive sub-beams SB1 and SB2 reflected by the optical disc 40. The photoelement 38 can turn on focusing and tracking when the photoelement 38 detects the output of the photodetectors. In this manner, a focus servo and a tracking servo are required in order to record and reproduce information, and the position accuracy of the photoelement is particularly important for the normal operation of the focus servo and the tracking servo.

In the conventional method of mounting a photoelement described above, when the position of the photoelement is adjusted, the substrate is moved around while the substrate is being pressed from the exterior by a position adjustment tool, and a UV-curable adhesive is then applied and cured to thereby fix the substrate in place. However, there is a problem in that the position and angle of the substrate readily become offset when the UV-curable adhesive is cured because resin enters into the space between the substrate and the mounting surface when the prescribed width is 0.1 to 0.5 mm. The amount of adhesive that is applied is increased when the width is too great, and the position more readily becomes offset due to expansion and contraction of the adhesive or due to other factors brought about by temperature variation of the optical head and the environment after the adhesive has been cured. On the other hand, when the substrate is made to adhere to the mounting surface, frictional force with the mounting surface is considerable, and there is therefore a problem in that the substrate is therefore difficult to move around and the position is difficult to adjust.

### SUMMARY OF THE INVENTION

It is therefore an object of the present invention to provide a method of mounting an optical component in which high-precision positioning is possible without the generation of position offset and angle offset when the UV-curable adhesive is cured. Another object of the present invention is to provide a high-performance optical pickup manufactured using such a mounting method.

The above and other objects of the present invention can be accomplished by a method of mounting an optical component, comprising a step for pressing an optical component to a mounting surface of a housing, a step for separating the optical component from the mounting surface within a prescribed distance while remaining parallel with the mounting surface, a step for finely adjusting the position and angle of the optical component, and a step for fixing the optical component to the mounting surface.

In the present invention, the step for fixing the optical component preferably includes a step for applying a UV-curable adhesive so that the optical component is affixed to the mounting surface, and a step for fixing the optical component by irradiating UV light to cure the UV-curable resin. Accordingly, the optical component can be reliably fixed in place in a simple manner.

In the present invention, the prescribed distance is preferably 300 μm or less, and particularly preferred is a prescribed distance of 1 μm or more and 300 μm or less. If the gap is 300 μm or less and the viscosity of the resin is 20,000 to 50,000 mPa·s, the UV-curable adhesive does not enter between the substrate 13 and the mounting surface 11a, and the position and angle of the substrate 13 do not become offset when the UV-curable resin is cured. When the gap is too wide and the amount of adhesive that is applied is too great, the position is more readily offset due to temperature variation of the optical pickup and the environment after curing. It is advantageous if the gap is 300 μm or less because the position is less likely to become offset at this gap. Also, the substrate is separated from the mounting surface while keeping the substrate parallel with the mounting surface, whereby frictional force with the mounting surface 11a is reduced and the position and angle of the substrate can be finely adjusted with greater ease.

In the present invention, a step is preferably further provided for adjusting the position of the optical axis direction of a sensor lens provided in a pre-stage of the optical component after the optical component is fixed in place. Accordingly, the position in the optical axis direction of the optical components can be finely adjusted in a relative manner.

In the present invention, the optical component is preferably a substrate on which a photoelement is mounted. The light source, lens, and other components of the optical system are mounted in the housing. Therefore, accurate positioning that has accounted for mounting errors of the light source, lens, and other components is required when the photoelement is mounted, and when the photoelement is mounted in accordance with the above-described method, the positioning accuracy of the photoelement can be assured, and a high-performance optical pickup can be achieved. In this case, the photoelement is preferably one that is used for recording and reproduction, focus control, and tracking control. It is particularly preferred that the photoelement comprise a main beam photodetector for receiving a main beam reflected by an optical disc, and a sub-beam photodetector for receiving a sub-beam reflected by the optical disc, and that the focus servo and the tracking servo be carried out by detecting the output of the main beam photodetector and the sub-beam detector.

The above and other objects of the present invention can also be accomplished by an optical pickup comprising at least an optical component and a housing having a mounting surface for the optical component, and in which the distance between the optical component and the mounting surface is 1 μm or more and 300 μm or less. In this case, the optical pickup of the present invention is preferably provided with a sensor lens provided in a pre-stage of the optical component, and the position of the sensor lens can be adjusted in the optical axis direction.

Thus, in accordance with the present invention, a method of mounting an optical component can be provided in which high-precision mounting is possible in a simple manner without the generation of position offset and angle offset when the UV-curable adhesive is cured.

### BRIEF DESCRIPTION OF THE DRAWINGS

The above and other object, features and advantages of this invention will become more apparent by reference to the following detailed description of the invention taken in conjunction with the accompanying drawings, wherein:

FIG. 1 is a schematic exploded perspective view that partially shows the configuration of an optical pickup;

FIG. 2 is a schematic view showing the configuration of the optical pickup mounting device 20;

FIGS. 3A, 3B and 3B are schematic diagrams for describing the steps of mounting the substrate 13;

FIGS. 4A and 4B are schematic diagrams for describing the steps of mounting the substrate 13;

FIG. 5 is a schematic diagram showing the general configuration of an optical pickup; and

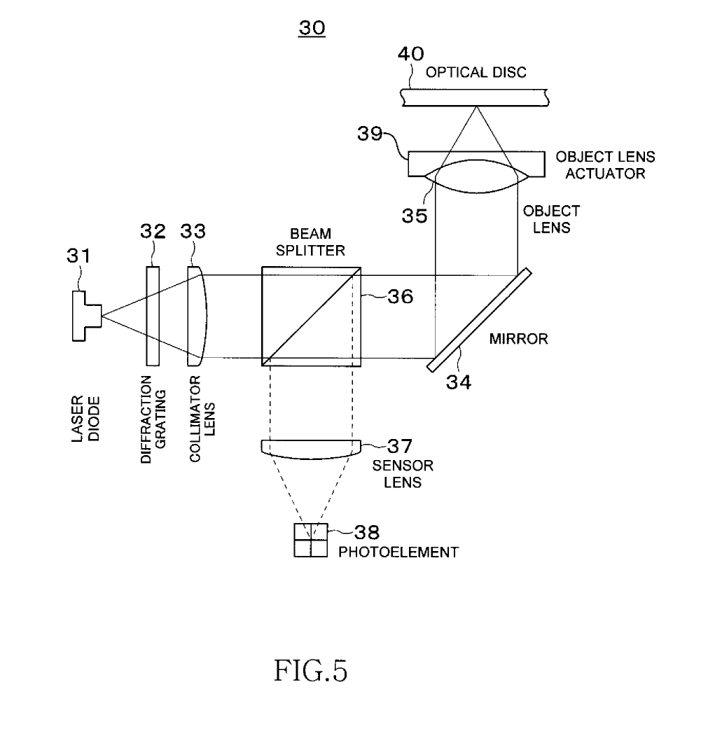

FIG. 6 is a schematic plan view showing the configuration of a photoelement 38.

### DESCRIPTION OF THE PREFERRED EMBODIMENTS

Preferred embodiments of the present invention will be described in detail hereinafter with reference to the accompanying drawings. In the present embodiment, a substrate on which a photoelement (PDIC) is mounted is used as an example of an optical component, and a method of mounting the substrate on the housing of an optical pickup will be described.

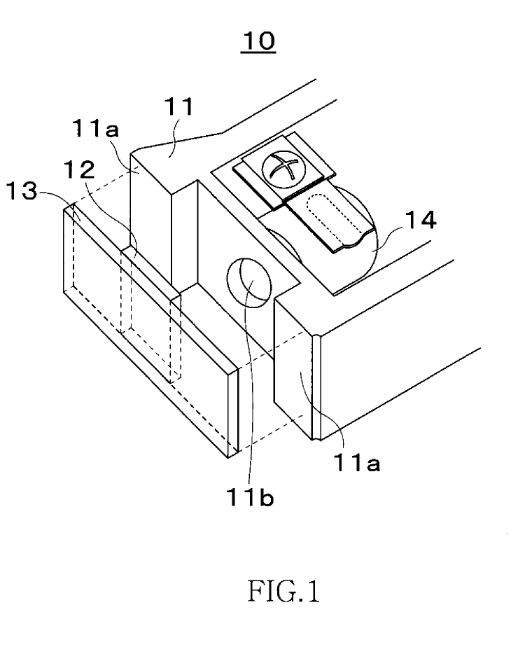

FIG. 1 is a schematic exploded perspective view that partially shows the configuration of an optical pickup.

As shown in FIG. 1, an optical pickup 10 comprises a housing 11 in which a light source, lens, and other components of an optical system are mounted. A mounting surface 11a for mounting a substrate 13 on which a photoelement 12 is mounted is formed on the side surface of the exterior of the housing 11. The two ends of the substrate 13 are mounted on the mounting surface 11a, whereby the photoelement 12 is mounted on the housing 11. In this case, the photoelement 12 is disposed on the optical axis of the optical system, which includes a sensor lens 14 that is disposed inside the housing 11. A beam that has passed through the sensor lens 14 passes through an aperture 11b formed in the side surface of the housing 11 and is irradiated onto the photoelement 12.

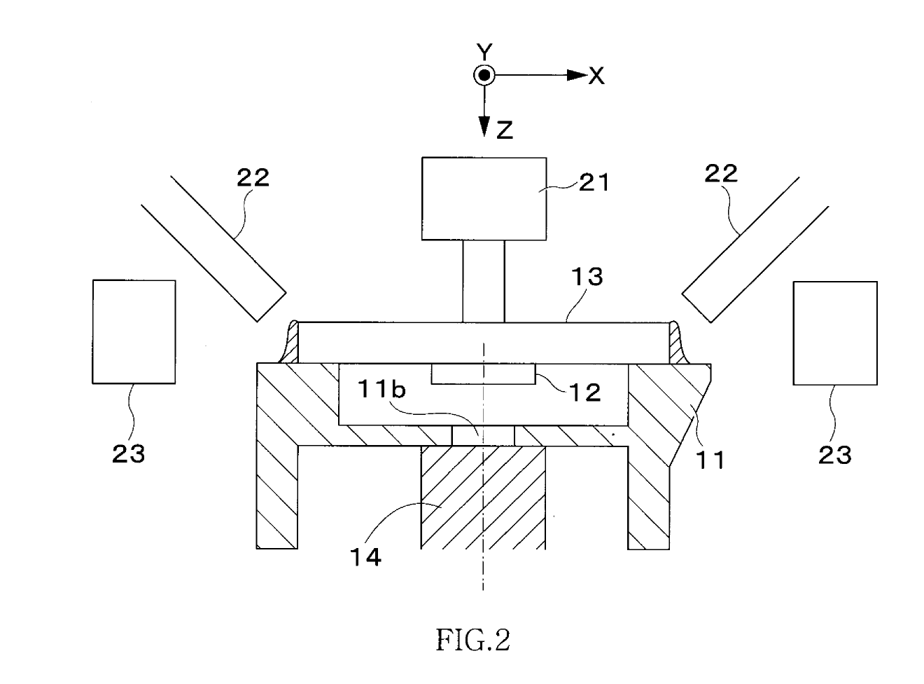

FIG. 2 is a schematic view showing the configuration of the optical pickup mounting device 20.

As shown in FIG. 2, the optical pickup mounting device 20 comprises a position adjustment jig 21 for holding the substrate 13 provided with the photoelement 12 and adjusting the position of the substrate 13, a dispenser 22 for applying UV-curable adhesive, and a UV irradiation apparatus 23 for curing the UV-curable adhesive. The housing 11 of the optical pickup is mounted on a support base (not shown) that serves as an absolute reference for positioning. The position adjustment jig 21 is capable of moving the substrate 13 in six axial directions, i.e., the X, Y, Z axes and the θx, θy, θz rotation axes, with respect to the support base. (The mounting position adjustment jig may be capable of moving the substrate 13 in a minimum of four directions, i.e., the X, Y, and Z axes, and the θz rotation axis.)

The step for mounting the photoelement is carried out in the final stage of the step for mounting the optical components of an optical pickup. The present step includes a procedure for adjusting the position of the photodetector of the photoelement so as to match the optimal reception position of return light from an optical disc which has become offset due to the variability in the position of the light source (laser diode 31) and other optical elements.

Since the optimal reception position is generated in 3D, the photoelement 12 may be moved and adjusted in three axial directions, i.e., X, Y, and Z (six axial directions when θ directions are also included), but when a method is used in which the photoelement 12 is adjusted in the Z-axis direction along the optical axis, a gap of about 500 μm must be assured in advance between the housing 11 and the fixed portion. Affixing the photoelement 12 so that the gap is bridged is not desirable in terms of environment resistance reliability because expansion is considerable when the resin adhesive thermally expands and absorbs moisture. In view of this situation, adjustment in the Z-axis direction is preferably carried out in a relative manner by sliding the position of the sensor lens 14 in the Z-axis direction and mechanically fixing the position of the photoelement in the Z-axis direction.

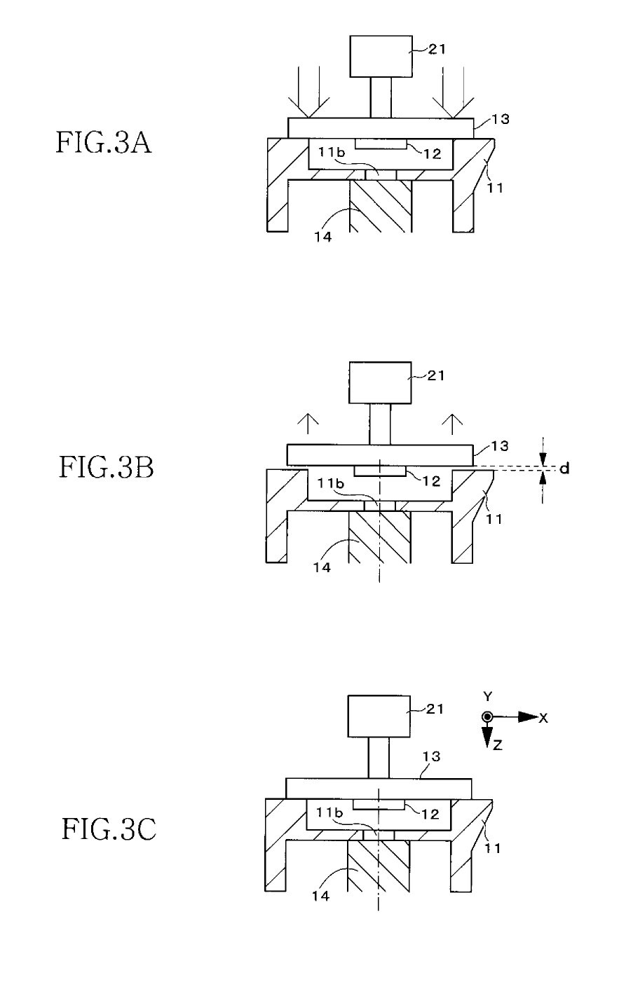

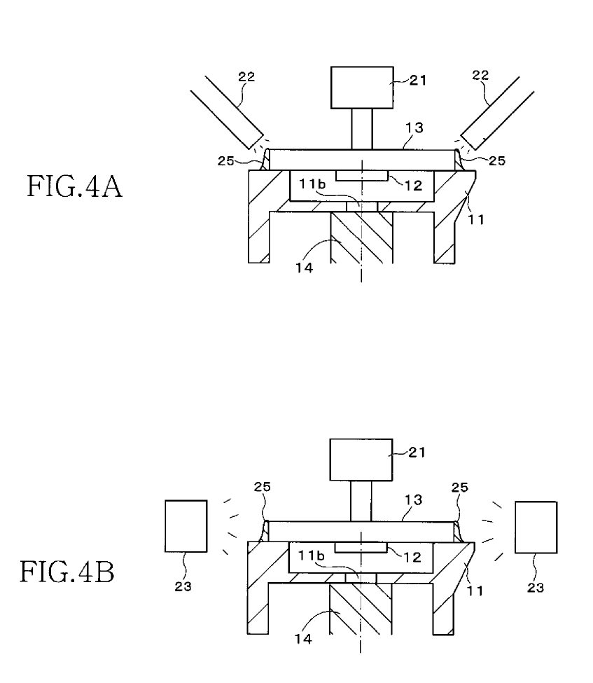

FIGS. 3A, 3B and 3C, and FIGS. 4A and 4B are schematic diagrams for describing the step of mounting the substrate 13.

As shown in FIG. 3A, the step of mounting the substrate 13 on the housing 11 entails setting the substrate 13 to face the mounting surface 11a of the housing 11 using a position adjustment jig 21, generally positioning the substrate 13 so that the position of the photoelement 12 substantially matches that of the aperture 11b, and thereafter pressing the substrate 13 to the mounting surface 11a of the housing 11. The substrate 13 can thereby be kept parallel to the housing 11.

Next, the substrate 13 is kept parallel to and slightly separated from the mounting surface 11a, as shown in FIG. 3B. The separation distance d at this time is preferably 300 μm or less, and is more preferably 1 μm or more and 300 μm or less. When 300 μm is exceeded, the UV-curable adhesive enters into the space between the substrate 13 and the mounting surface 11a when the later-described UV-curable resin is applied, and the position and angle of the substrate 13 therefore becomes offset when the UV-curable adhesive is cured. However, no such problem occurs when the distance is 300 μm or less, and the photoelement 12 can therefore be positioned with high precision. When the distance is 1 μm or less, frictional force against the mounting surface 11a is considerable, and it therefore becomes difficult to move the substrate 13 around and to finely adjust the position and angle. However, no such problem occurs when the distance is 1 μm or more, and the substrate 13 can be smoothly moved. The separation distance d can be adjusted while viewing a micrometer, which is one of the functions of the position adjustment jig 21.

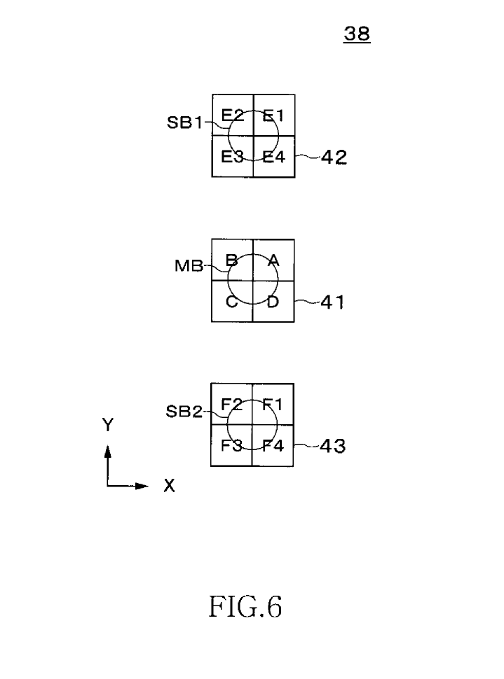

Next, the mounting position of the substrate 13 is finely adjusted, as shown in FIG. 3C. Since the light source, lens, and other optical system components have already been mounted in the housing 11, accurate positioning that has accounted for mounting errors of the light source, lens, and other components is required when the photoelement 12 is mounted. Fine adjustment of the position is carried out when the main beam MB and sub-beams SB1 and SB2 reflected by the optical disc form an image at substantially the center of the photodetectors 41 through 43, respectively, of the photoelement 12, and the relative position of the substrate 13 is adjusted so that the shape of the beam spots substantially form a perfect circle, as shown in FIG. 6. An error of only about 100 microns is allowed in this case, and the adjustment must therefore be performed very carefully. This fine adjustment is performed with respect to the above-described six axes, for example. In such a case, the distance d between the substrate surface and the mounting surface 11a is kept to 1 μm or more and 300 μm or less.

Next, the UV-curable adhesive 25 is applied to the vicinity of the side end surface of the substrate 13 using a dispenser 22. When the UV-curable adhesive 25 is to be applied, the UV-curable adhesive, which projects in the shape of a sphere from the distal end of the discharge portion of the dispenser 22, is caused to make contact with the side end surface of the substrate 13 and the periphery of the mounting surface 11a of the housing 11.

Lastly, UV rays are irradiated onto the UV-curable adhesive 25 using a UV irradiation apparatus 23 while the position of the substrate 13 is maintained, as shown in FIG. 4B, and the UV-curable adhesive 25 is cured. The substrate 13 is thereby fixed on the housing 11. When further fine adjustment of the photoelement in the Z-axis direction is desired, the position of the sensor lens 14 in the Z-axis direction is adjusted while the photoelement 12 remains fixed in place, whereby the relative position of the photoelement 12 with respect to the sensor lens 14 is adjusted. The optical pickup 10 is completed when the above-described steps have been completed.

As described above, in accordance with the present embodiment, the substrate 13 in which the photoelement 12 is mounted is pressed to the mounting surface 11a of the housing 11, the substrate surface of the substrate 13 and the mounting surface 11a are kept parallel, the substrate 13 is separated from the mounting surface 11a by a prescribed distance, i.e., 1 μm or more and 300 μm or less, and the position of the substrate 13 is finely adjusted in this position. Therefore, the problem in which the position and angle of the photoelement 12 become offset when the UV-curable adhesive 25 is cured is resolved, and the position of the substrate 13 is not liable to become offset due to temperature variations in the optical head and the environment after the adhesive has cured.

The present invention has thus been shown and described with reference to specific embodiments. However, it should be noted that the present invention is in no way limited to the details of the described arrangements but changes and modifications may be made without departing from the scope of the appended claims.

For example, in the above embodiments, a substrate on which a photoelement is mounted is used as an optical component. However, the present invention is not limited to the substrate on which a photoelement is mounted, and a photoelement alone having a shape that can be mounted on the mounting surface is also possible. Also, a laser diode or another light-emitting element may be used. In other words, the component may be any component as long as it is an optical element that requires high-precision positioning.

In the above embodiments, UV-curable adhesive is used as the adhesive for fixing the substrate 13 on which a photoelement 12 is mounted onto the mounting surface 11a of a housing 11, but the present invention is not limited to a UV-curable adhesive, and a heat-curing resin or another adhesive may be used.

What is claimed is:

1. A method of mounting an optical component, comprising the steps of:
pressing an optical component to a mounting surface of a housing;
separating the optical component from the mounting surface within a prescribed distance while remaining parallel with the mounting surface;
adjusting the position and angle of the optical component; and
fixing the optical component to the mounting surface.

2. The method of mounting an optical component as claimed in claim 1, wherein the step of fixing the optical component includes the steps of applying a UV-curable adhesive so that the optical component is affixed to the mounting surface, and fixing the optical component by irradiating UV light to cure the UV-curable resin.

3. The method of mounting an optical component as claimed in claim 1, wherein the prescribed distance is 300 μm or less.

4. The method of mounting an optical component as claimed in claim 1, wherein the prescribed distance is 1 μm or more and 300 μm or less.

5. The method of mounting an optical component as claimed in claim 1, wherein the optical component is a substrate on which a photoelement is mounted.

6. The method of mounting an optical component as claimed in claim 1, wherein the photoelement is used for recording and reproduction, focus control, and tracking control in an optical pickup.

7. The method of mounting an optical component as claimed in claim 6, wherein the photoelement comprise a main beam photodetector for receiving a main beam reflected by an optical disc, and a sub-beam photodetector for receiving a sub-beam reflected by the optical disc, wherein the focus servo and the tracking servo are carried out by detecting the output of the main beam photodetector and the sub-beam detector.

8. The method of mounting an optical component as claimed in claim 1, further comprising the step of adjusting the position of the optical axis direction of a sensor lens provided in a pre-stage of the optical component after the optical component is fixed in place.

9. An optical pickup, comprising:
an optical component; and
a housing having a mounting surface for the optical component, wherein the distance between the optical component and the mounting surface is 1 μm or more and 300 μm or less.

10. The optical pickup as claimed in claim 9, further comprising a sensor lens provided in a pre-stage of the optical component, wherein the position of the sensor lens can be adjusted in the optical axis direction.
